(19) United States
(12) Patent Application Publication
(10) Pub. No.: US 2017/0076411 A1
(43) Pub. Date: Mar. 16, 2017

(54) NOTARY AND FINGERPRINTING REQUEST SYSTEM AND METHOD FOR SATISFYING NOTARY AND FINGERPRINTING REQUESTS

(71) Applicant: Veasna Mao, LOS ANGELES, CA (US)

(72) Inventor: Veasna Mao, LOS ANGELES, CA (US)

(21) Appl. No.: 15/152,839

(22) Filed: May 12, 2016

Related U.S. Application Data
(60) Provisional application No. 62/216,597, filed on Sep. 10, 2015.

(51) Int. Cl. G06Q 50/18; G06Q 20/32; G06Q 20/40; G06Q 50/26

(52) U.S. Cl. CPC G06Q 50/18; G06Q 50/265; G06Q 20/322; G06Q 20/401

(57) ABSTRACT

A system and a process are disclosed for fulfilling notary and fingerprinting requests. In fulfilling notary and fingerprinting requests, a customer is connected to an agent who can fulfill one of a notary request from the customer and a fingerprinting request from the customer. The process is implemented as a software application that connects to a cloud-network service to fulfill notary and fingerprinting requests at any time, 24/7.

### CLAIM OF BENEFIT TO PRIOR APPLICATION

This application claims benefit to U.S. Provisional Patent Application 62/216,597, entitled “Notinger 24/7 ‘Notary/Fingerprinting on the go’,” filed Sep. 10, 2015. The U.S. Provisional Patent Application 62/216,597 is incorporated herein by reference.

### BACKGROUND

Many people require the services of a notary agent. However, at any given time it is typically a hassle to find a notary agent. While it is possible to travel to the office of a notary agent, many people need a notary during off-hours or cannot travel to a notary. In general, the existing mechanism for linking people to notary agents is slow and involves needless busy work on the part of the person needing the notary services.

Therefore, there is a need for a convenient way for a customer to order services of a notary agent and faster communication between the notary agent and the customer in need of services provided by the notary agent.

### BRIEF DESCRIPTION

In this specification, a notary and fingerprinting request system and a method for satisfying notary and fingerprinting requests are disclosed. The notary and fingerprinting request system connects customers to notary agents via computing devices, such as mobile devices, to satisfy notary and fingerprinting requests. In satisfying notary and fingerprinting requests, the notary and fingerprinting request system connects the customer to one agent in a pool of possible agents who can satisfy either or both of a notary request from the customer and a fingerprinting request from the customer.

The method for satisfying notary and fingerprinting requests is initiated by customers who connect via computing devices, such as mobile devices, to computing devices, such as mobile devices, of notary agents. In a preferred embodiment, the method for satisfying notary and fingerprinting requests is implemented as a mobile application on a mobile device. The mobile device can be any of several mobile computing and/or communication devices, such as a smartphone or a tablet computing device.

When the method for satisfying notary and fingerprinting requests is implemented as a notary request and fingerprinting mobile application, the customer can interact with the mobile application to select services, request an agent, and select other related options. In some embodiments, the notary request and fingerprinting mobile application connects to a cloud-network service to satisfy notary and fingerprinting requests at any time, 24/7.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a method for satisfying notary and fingerprinting requests in some embodiments.

FIG. 2 conceptually illustrates a notary and fingerprinting request system of some embodiments that connects customers to notary agents to satisfy notary and fingerprinting requests.

FIG. 3 conceptually illustrates an example of an agent sign up method.

FIG. 4 conceptually illustrates an example of an agent live mode method.

FIG. 5 conceptually illustrates an example of a customer registration method and a method for providing customer payment information.

FIG. 6 conceptually illustrates an example of a customer live mode method.

FIG. 7 conceptually illustrates an example of agent sign up and account creation.

FIG. 8 conceptually illustrates an example of agent type selection.

FIG. 9 conceptually illustrates an example of agent approval and launch.

FIG. 10 conceptually illustrates an example of agent experience selection.

FIG. 11 conceptually illustrates an agent sign-up method in some embodiments.

FIG. 12 conceptually illustrates an agent live mode method in some embodiments.

FIG. 13 conceptually illustrates a secure method for self-fingerprinting by a customer in some embodiments.

FIG. 14 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

In a preferred embodiment, the method for satisfying notary and fingerprinting requests is implemented as a mobile application on a mobile device. The mobile device can be any of several mobile computing and/or communication devices, such as a smartphone or a tablet computing device.

When the method for satisfying notary and fingerprinting requests is implemented as a notary request and fingerprinting mobile application, the customer can interact with the mobile application to select services, request an agent, and select other related options. In some embodiments, the notary request and fingerprinting mobile application connects to a cloud-network service to satisfy notary and fingerprinting requests at any time, 24/7.

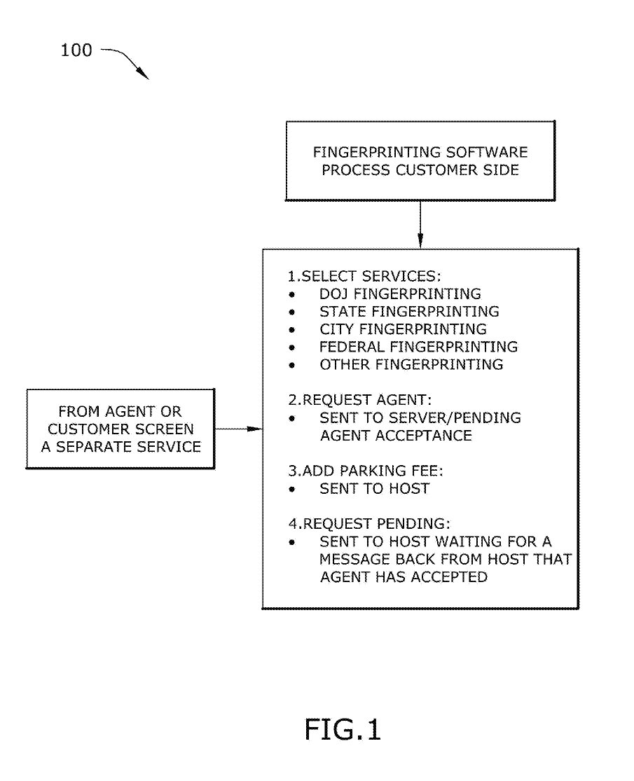

By way of example, FIG. 1 conceptually illustrates a method 100 for satisfying notary and fingerprinting requests. The method 100 shown in this figure includes steps for selecting services, requesting an agent, adding a parking fee, and maintaining the request for the agent's services as pending until the services are completed.

Thus, a customer with a mobile device initiates the method 100 for satisfying notary and fingerprinting requests. When the method 100 is implemented as a fingerprinting mobile application that runs on a mobile device, the customer can interact with the application to select the services, request the agent, and add the parking fee. For services, the customer selects one or more of the available services, such as Department of Justice (DOJ) fingerprinting, Federal Bureau of Investigation (FBI) fingerprinting or both. For agent request, the customer sends out a request and the customer accepts on his/her mobile or computing device. Additionally, in some embodiments, the agent is responsible for parking fees. After these items are processed, the request remains pending at the host until an agent accepts the request and a message is sent back to the customer.

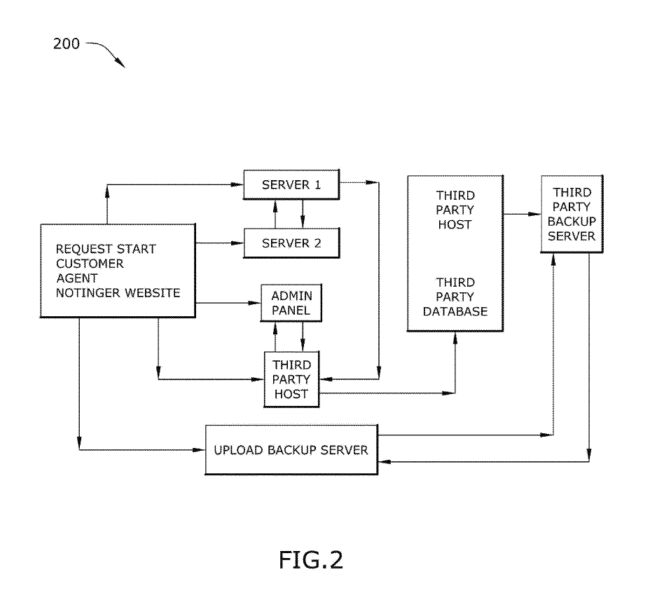

In some embodiments, the notary and fingerprinting request method system connects customers to notary agents via mobile devices to satisfy notary and fingerprinting requests. In satisfying notary and fingerprinting requests, the notary and fingerprinting request method system connects the customer to nearest agent in a pool of possible agents. Typically, a customer accesses the notary and fingerprinting request method system with a mobile device, such as a smartphone or a tablet computing device. By way of example, FIG. 2 conceptually illustrates a notary and fingerprinting request method system 200 that connects customers to notary agents to satisfy notary and fingerprinting requests. As shown in this figure, the notary and fingerprinting request method system 200 includes server computing devices (or “host computing devices”) server 1 and server 2, an admin panel, a third party host, a third party database, an upload backup server and another third party host, a third party backup server, and an upload backup server. A request from the mobile device of a customer typically starts off the operations of the notary and fingerprinting request method system 200. For instance, a request could be made to server 1 or server 2, a request to the admin panel could be made, or a request could be made to the upload backup server. Each of the servers (server 1 and server 2) communicate with each other, while server 1 communicates with the third party host, as well as the admin panel. In some embodiments, the third party host connects to a third party database associated with the third party host (or another third party host). In some cases, there may be a third party backup server which makes routine archival copies of the third party database. The third party backup server may also connect to an upload backup server.

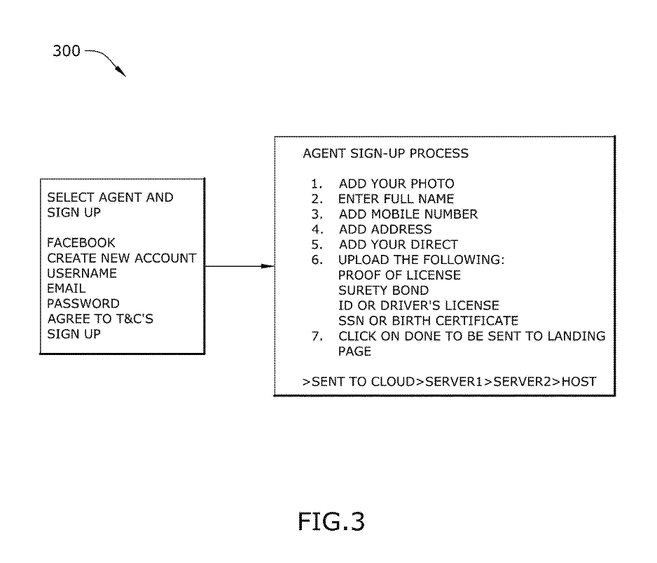

An agent, such as a licensed notary agent, may register and sign into the notary and fingerprinting request method system directly by downloading the app and registering on their mobile device. Typically, an agent with a mobile device, such as a smartphone or a tablet computing device, can use the notary and fingerprinting request method system 200 to make their notary and fingering printing services available to others. When the agent is establishing a new account, the agent can perform a registration and sign-in via a qualified social media platform (such as Facebook®) or directly by tapping on the register as “New User” in mobile application. An example of an agent sign up method 300 is conceptually illustrated in FIG. 3.

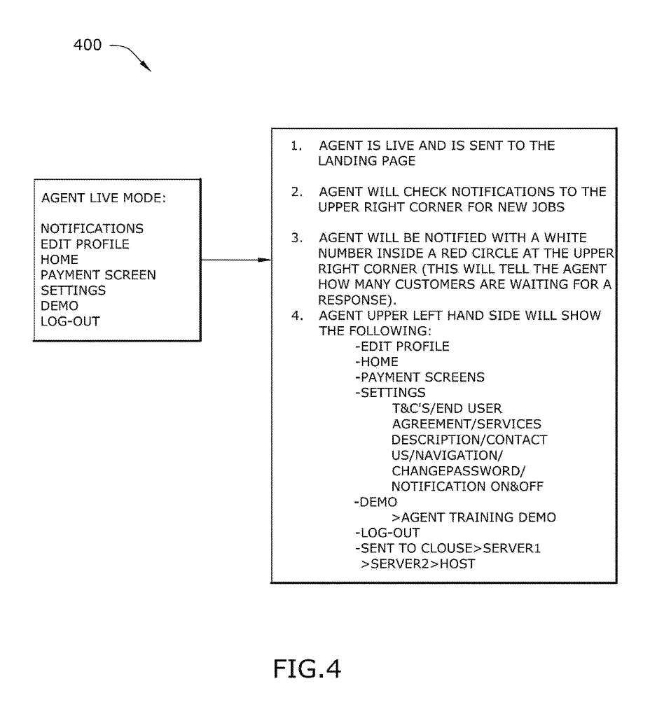

After the agent is registered and has signed-in, an administrator will verify agent documentation and set the agent to live mode once approved. The agent will then be available to serve notary and/or fingerprinting requests of customers. An example of an agent live mode method 400 is conceptually illustrated in FIG. 4.

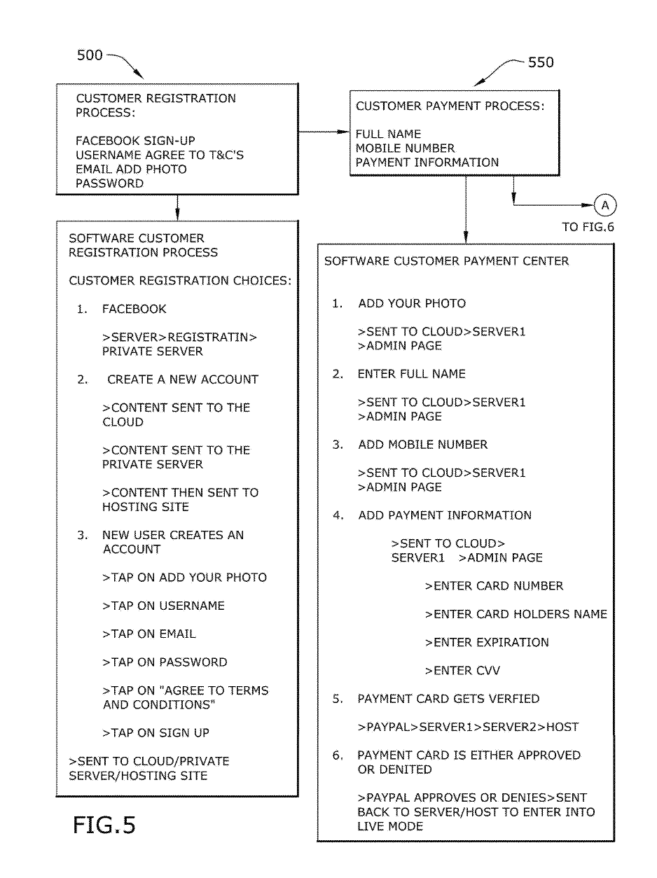

For customers, registration and sign up can be made in similar ways, namely, through a supported social media platform (such as Facebook®) or directly by tapping on the register as “New User” in mobile application. An example of a customer registration method 500 is conceptually illustrated in FIG. 5. When the customer signs up through the social media platform or directly by tapping on the register as “New User” in application, the customer will then be able to interact with a variety of services. Examples of the types of services offered include, without limitation, Standard Notary, Special Services, Loan Signing, Certifications, Immigration and Legal Advice, etc. After the customer selects a service, the customer can then taps on request an agent and the request will be sent to the nearest agent. In some implementations, the customer may use a pointing device (such as tablet pen) or make a finger gesture (such as a tap on a touch-sensitive display screen) to request an agent. The app would then connect the customer immediately with a live agent nearby.

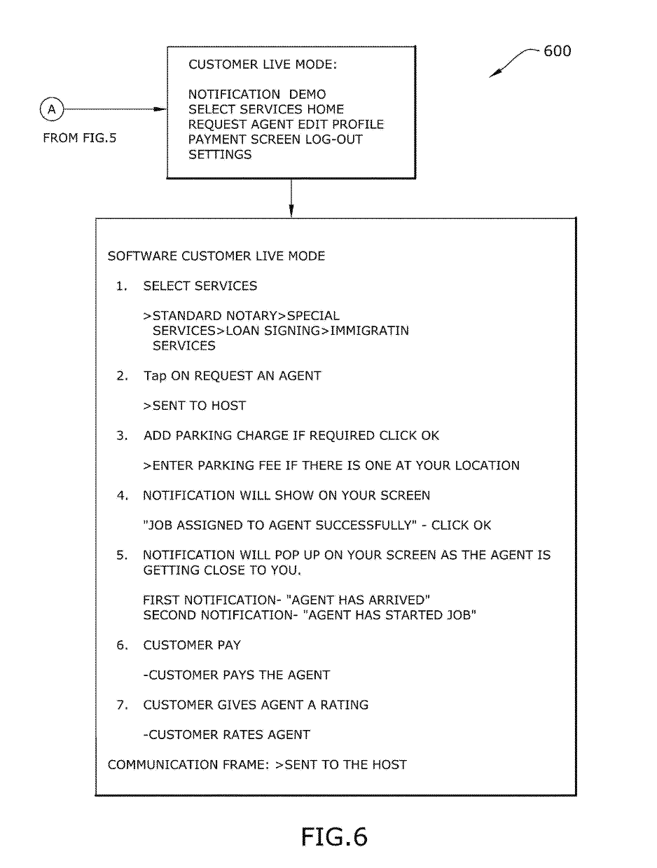

In some embodiments, a customer provides payment information for notary and fingerprinting services in advance of interacting with the notary agent. An example of a method 550 for providing payment information is conceptually illustrated in FIG. 5. After payment information is provided, the customer may then be set for live mode interaction with agents in the agent pool. An example of a customer live mode method 600 is conceptually illustrated in FIG. 6. In this way, the agent can be assured of payment (because the customer has already provided payment information). After service is completed by an agent and the customer makes payment to the agent, then customer will be given an opportunity to rate the quality of the service received from the agent.

The notary and fingerprinting request system differs from and improves upon currently existing options. In particular, some embodiments of the notary and fingerprinting request system differ by providing greater convenience and time efficiency. The services that are offered are comprehensive and easy to access via the mobile app. In addition, the notary and fingerprinting request system improves upon the currently existing options by reducing costs to the customers while still providing the most convenient and time efficient manner of completing notary service requests, all of which are initiated and performed by in large via mobile application on the customer's mobile device.

The mobile application that runs on the customer's mobile device is designed to be used anytime or anywhere. In some embodiments, the mobile application embeds Internet/Satellite/Mobile2Mobile connectivity inside of the mobile application.

The method for satisfying notary and fingerprinting requests of the present disclosure may be comprised of the following steps. This list of possible constituent steps is intended to be exemplary only and it is not intended that this list be used to limit the method for satisfying notary and fingerprinting requests of the present application to just these steps. Persons having ordinary skill in the art relevant to the present disclosure may understand there to be equivalent steps that may be substituted within the present disclosure without changing the essential function or operation of the method for fulfilling notary and fingerprinting requests.

1. Customer/Agent signs up (e.g., through Facebook® or create a new account)

2. Customer will provide credit card to pay for services

3. Customer will go live and select the services they need

4. Customer will tap on request an agent

5. Agent will accept or decline

6. Agent will tap on arrive when agent arrives

7. Agent will tap on start job when the job has started

8. Agent will perform services

9. Agent will ask customer to pay and rate agent

10. Customer will tap on pay

11. Agent will get paid immediately

12. Customer will now rate their agent

13. Agent goes back into the queue, ready to accept another job

The relationship between customer and agent sign up are pretty similar but the customer will provide a credit card to pay for services at time of registration and the agent will provide proof of documentation, bank account and routing numbers, address, email, first and last name and submit proof of Identification.

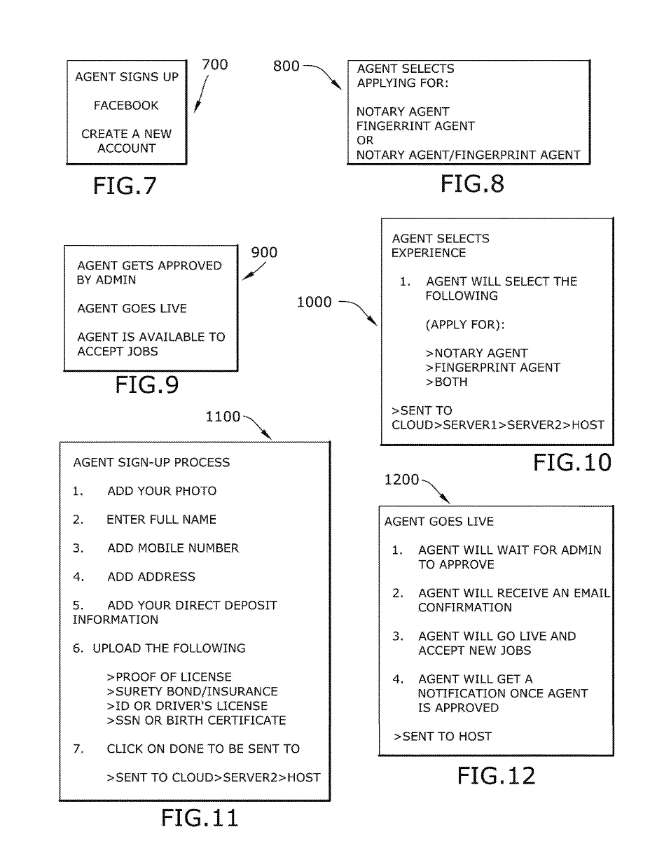

The agent information will be secured on their devices and by Symantec numeric pin code. By way of example, FIG. 7 conceptually illustrates an example of agent sign up and account creation 700. Another example shows agent type selection 800 in FIG. 8. In some embodiments, an additional step is made for any new agent registration or sign-up, such that an administrator would need to approve the new agent account prior to the agent going live. FIG. 9 conceptually illustrates one such example of agent approval and launch 900. To flesh out the details of the agent, more information can be provided. For example, the agent may wish to highlight his or her experience level. Turning to FIG. 10, an example of agent experience selection 1000 is shown. To further flesh out agent details and information, the agent may wish to provide more biographical information, such as their full name and/or a photo. Also, the agent may provide banking information, such as direct deposit account information to get paid, etc. Such further agent information is described by reference to FIG. 11, which conceptually illustrates an agent sign-up method 1100. When all the above steps are completed, the agent is ready to go live. Thus, an agent live mode method 1200 is conceptually illustrated in FIG. 12.

The operations of the method for satisfying notary and fingerprinting requests are performed by an application (or “app” for short) and carried out on an operating system (OS) platform. Supported OS platforms include typical mobile OS platforms, such as Android®, iOS®, Windows®, etc. The phone service is integrated into the app along with the navigation. The map integrates pins to identify agents and the customer is identified by an orange pin, the agent are identified by a blue pin and when agent is not available the pin is red. The app code is written in a variety of coding languages with several modules of the app code-base being combined into functionally working groups. The programming languages include, without limitation, C++, Ruby on Rails, JavaScript, Python, etc., as well as proprietary application programming interfaces (API), such as those provided by social media platforms (e.g., Facebook®), payment platforms (e.g., PayPal®), mapping and navigation platforms (e.g., Waze®, Google Maps®, etc.), and/or different phone calling services depending on users calling service. One or more native databases are deployed within the app and/or accessible as a cloud-network resource when connecting to the service.

Typical usage patterns include logical determinations that must be made by the system at one or more instances, such as: if customer requests the agent will receive; if agent accepts, agent will be routed to customer; if agent declines then agent goes back in queue; if agent taps on arrive then customer has 5 minutes to locate agent; if agent taps on start job then customer will get charged $7 dollars if agent taps cancel; if customer taps on pay then agent gets paid; and if customer taps on rate then agents rating get sent to our founder for review.

To use the method for satisfying notary and fingerprinting requests of the present disclosure, the customer will sign up, select the service they need, and request an agent. The agent would accept or decline. Instead of a customer planning their entire day to go to a location and wait in line to get services, the method for satisfying notary and fingerprinting requests is implemented as a mobile app so that the customer can just request the service, and the agent will then travel to the customer's location. This is true whether the customer is at home, at work, at a park, or any other accessible location, so long as there is an Internet/Satellite/Mobile2Mobile connection.

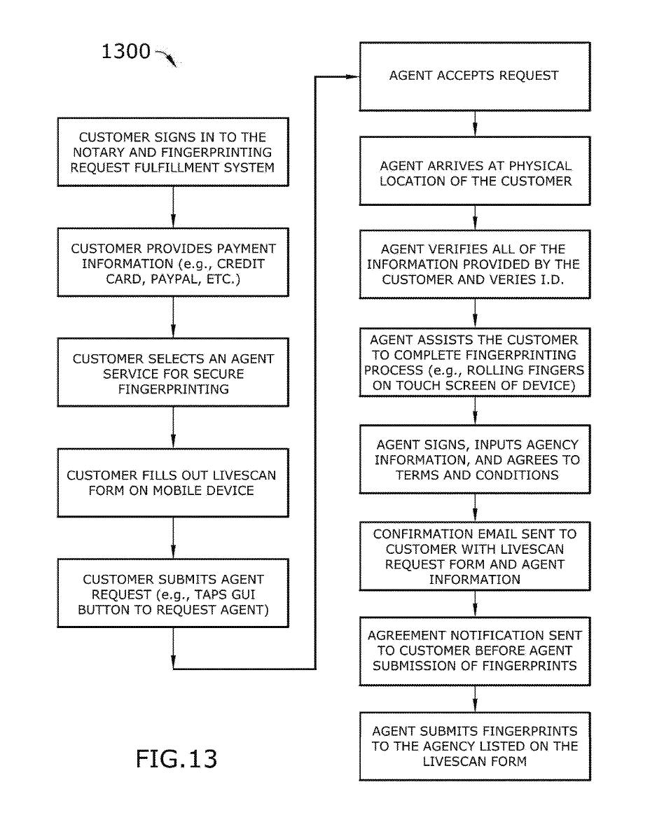

In the next example, described by reference to FIG. 13, a secure method for self-fingerprinting by a customer 1300 is shown. Unlike the examples described above, the secure method for self-fingerprinting by a customer 1300 focuses on capturing a customer's fingerprints on a mobile device. Being a secure method, the mobile device that captures the customer's fingerprints is typically the customer's own mobile device. This ensures that throughout all steps of the method, including capturing fingerprints, transferring fingerprints, and maintaining or deleting the captured fingerprints when the method is complete, the fingerprints of the customer will not fall into wrong hands to be used in the falsification of documents or other illegal, deceitful, or improper activities related in one way or another to identity theft (namely, theft of the customer's fingerprints). As shown in this figure, the secure method for self-fingerprinting by a customer 1300 is initiated by the customer. Specifically, the customer fills out a Livescan form in relation to capturing fingerprints electronically, instead of using traditional ink-based methods for capturing fingerprints. The Livescan form includes biographical information about the customer, which is verified by the agent upon arrival at the customer's physical location. The Livescan form also includes the name of an agency to which the electronic fingerprints are to be transmitted. After verification of all the information in the Livescan form, and checking the customer's identification, the agent instructs or assists the customer in rolling his or her finger on the touch-sensitive screen to receive the fingerprints electronically. Confirmation emails and agreement notifications are sent to the customer, and after they are received, the agent submits the electronic fingerprints to the receiving agency.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention.

Also, many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the terms “software”, “application”, “app”, and “mobile app” (referred to below as “software”) are meant to include firmware residing in read-only memory or applications stored in magnetic storage, which can be read into memory for processing by a processor, such as the processor of a mobile computing device or a mobile communication device, such as a smartphone, a hand-held computing device, or a tablet computing device (referred to simply as a “mobile device”), or the processor of a traditional computing device, such as a server computer, a desktop computer, or a laptop computer (referred to simply as a “computer”). Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

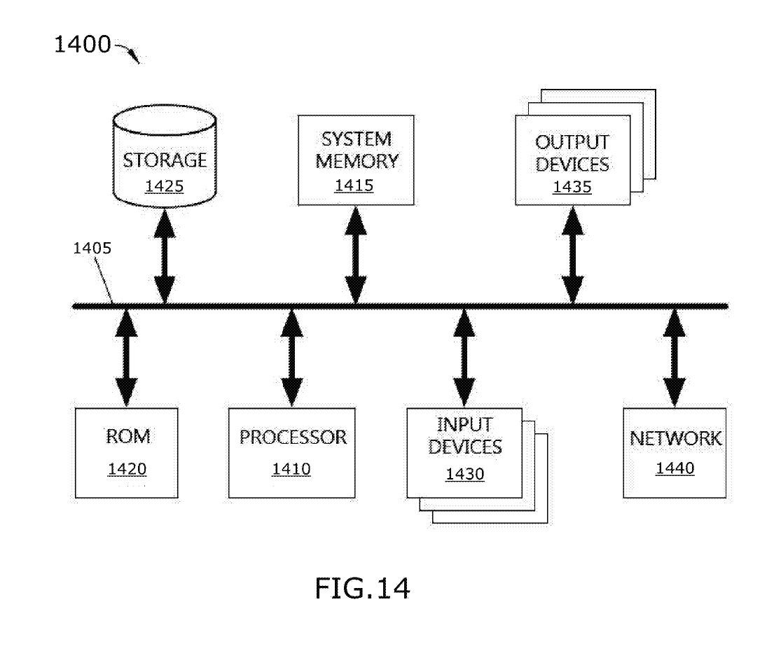

FIG. 14 conceptually illustrates an electronic system 1400 with which some embodiments of the invention are implemented. The electronic system 1400 may be a computer, mobile device, tablet, phone, PDA, or any other sort of electronic device. Such an electronic system includes various types of computer readable media and interfaces for various other types of computer readable media. Electronic system 1400 includes a bus 1405, processing unit(s) 1410, a system memory 1415, a read-only 1420, a permanent storage device 1425, input devices 1430, output devices 1435, and a network 1440.

The bus 1405 collectively represents all system, peripheral, and chipset buses that communicatively connect the numerous internal devices of the electronic system 1400. For instance, the bus 1405 communicatively connects the processing unit(s) 1410 with the read-only 1420, the system memory 1415, and the permanent storage device 1425.

From these various memory units, the processing unit(s) 1410 retrieves instructions to execute and data to process in order to execute the processes of the invention. The processing unit(s) may be a single processor or a multi-core processor in different embodiments.

The read-only-memory (ROM) 1420 stores static data and instructions that are needed by the processing unit(s) 1410 and other modules of the electronic system. The permanent storage device 1425, on the other hand, is a read-and-write memory device. This device is a non-volatile memory unit that stores instructions and data even when the electronic system 1400 is off. Some embodiments of the invention use a mass-storage device (such as a magnetic or optical disk and its corresponding disk drive) as the permanent storage device 1425.

Other embodiments use a removable storage device (such as a floppy disk or a flash drive) as the permanent storage device 1425. Like the permanent storage device 1425, the system memory 1415 is a read-and-write memory device. However, unlike storage device 1425, the system memory 1415 is a volatile read-and-write memory, such as a random access memory. The system memory 1415 stores some of the instructions and data that the processor needs at runtime. In some embodiments, the invention's processes are stored in the system memory 1415, the permanent storage device 1425, and/or the read-only 1420. For example, the various memory units include instructions for processing appearance alterations of displayable characters in accordance with some embodiments. From these various memory units, the processing unit(s) 1410 retrieves instructions to execute and data to process in order to execute the processes of some embodiments.

The bus 1405 also connects to the input and output devices 1430 and 1435. The input devices enable the user to communicate information and select commands to the electronic system. The input devices 1430 include keyboards and cursor control devices. The output devices 1435 display images generated by the electronic system 1400. Some embodiments include output devices 1435 such as a touchscreen laser fingerprint imaging.

Finally, as shown in FIG. 14, bus 1405 also couples electronic system 1400 to a network 1440 through a network adapter (not shown). In this manner, the computer can be a part of a network of computers (such as a local area network (“LAN”), a wide area network (“WAN”), or an intranet), or a network of networks (such as the Internet). Any or all components of electronic system 1400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, many of the drawings conceptually illustrate processes. The specific operations of these processes may not be performed in the exact order shown and described. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a mobile device presents a list of agents for selection by a customer to request notary and fingerprinting services, said program comprising sets of instructions for:
selecting a notary service to be completed by an agent;
requesting a particular agent from the list of agents, said particular agent requested to arrive at a physical location of the customer; and
receiving a confirmation of agent acceptance.

2. The non-transitory computer readable medium of claim 1, wherein the notary service to be completed by the agent comprises one or more of fingerprints for Department of Justice (DOJ) and fingerprints for Federal Bureau of Investigation (FBI).

3. The non-transitory computer readable medium of claim 1, wherein the set of instructions for requesting a particular agent from the list of agents comprises a set of instructions for identifying an agent who is physically closer to the location of the customer than other agents.

4. The non-transitory computer readable medium of claim 1, wherein the program further comprises sets of instructions for:
identifying a customer account associated with the customer by matching a login username and a login password to the customer account;
extracting an address of the customer from the customer account; and
providing the address of the customer to the particular agent to use in arriving at the physical location of the customer.

5. A non-transitory computer readable medium storing a program which when executed by at least one processing unit of a mobile device allows a customer to register a customer account to request notary fingerprinting services, said program comprising sets of instructions for:
receiving a set of customer account login credentials comprising a username and a password;
receiving an acceptance of a set of terms and conditions for creation of the customer account;
receiving at least one of an email address of the customer and a photo of the customer;
receiving payment account information from the customer;
displaying a set of agent services for the customer to review and select;
receiving an agent request in relation to a notary service job specified by the customer;
receiving a parking charge payment for parking by an agent near the location of the customer;
displaying a job acceptance confirmation that a particular agent has accepted the notary service job;
displaying a first notification when the particular agent is approaching the location of the customer;
displaying a second notification when the particular agent has arrive at the customer location; and
displaying a third notification when the particular agent has started the notary service job.

6. The non-transitory computer readable medium of claim 5, wherein the notary service job comprises one or more of standard notary service, special notary services, loan signing, and immigration services.

7. The non-transitory computer readable medium of claim 5, wherein the customer pays the agent upon completion of the notary service job.

8. A non-transitory computer readable medium storing a secure self-fingerprinting program which when executed by at least one processing unit of a mobile device of a customer obtains fingerprints of the customer, said secure self-fingerprinting program comprising sets of instructions for:
receiving a set of customer account login credentials comprising a username and a password;
receiving payment account information from the customer;
receiving a selection of a secure livescan fingerprinting service associated with an agent;
receiving a set of information related to a livescan form;
receiving an agent request in relation to the secure livescan fingerprinting service specified by the customer;
receiving acceptance of the agent request by a particular agent;
capturing fingerprints of the customer electronically; and
submitting the captured fingerprints by the agent, said fingerprints submitted to an agency specified by the customer in the livescan form.

9. The non-transitory computer readable medium of claim 8, wherein the set of instructions for capturing fingerprints of the customer electronically comprises sets of instructions for:
scanning the fingerprints of the customer when a finger of the customer is placed on a touch-sensitive display screen of a mobile computing device; and
storing the captured fingerprints of the customer in a secure data storage of the mobile computing device.

10. The non-transitory computer readable medium of claim 8, wherein the payment account information comprises at least one of a credit card account and an online electronic payment platform account.
